(19) United States
(12) Patent Application Publication
(10) Pub. No.: US 2021/0165465 A1
(43) Pub. Date: Jun. 3, 2021

(54) HYDRAULIC HINGE ASSEMBLIES

(71) Applicant: Hewlett-Packard Development Company, L.P., Spring, TX (US)

(72) Inventors: Shih-Hsun Huang, Taipei City (TW); Ya-Ting Yeh, Taipei City (TW)

(73) Assignee: Hewlett-Packard Development Company, L.P., Spring, TX (US)

(21) Appl. No.: 17/047,213

(22) PCT Filed: Jun. 6, 2018
(86) PCT No.: PCT/US2018/036175

§ 371 Date: Oct. 13, 2020

(51) Int. Cl. G06F 1/16; F15B 11/22

(52) U.S. Cl. CPC G06F 1/1681; E05D 11/00; F15B 11/22

(57) ABSTRACT

In one example, a hinge assembly may include a first hinge member and a second hinge member. The first hinge member may include a first hinge base and a first hinge bracket pivotally connected to the first hinge base. The second hinge member may include a second hinge base and a second hinge bracket pivotally connected to the second hinge base. Further, the hinge assembly may include a hydraulic unit connected between the first hinge member and the second hinge member to provide synchronous movements between the first hinge bracket and the second hinge bracket.

### BACKGROUND

Electronic devices such as laptop computers, mobile phones, personal digital assistants, and the like may include a base portion, a display portion, and a pair of hinges mounted between the base portion and the display portion. For example, the base portion may house a keyboard, a motherboard, and/or other components, The display portion may house a display, such as a flexible display. The pair of hinges may connect the display portion to the base portion and allow the display portion to rotate relative to the base portion.

### BRIEF DESCRIPTION OF DRAWINGS

Examples are described in the following detailed description and in reference o the drawings, in which:

FIG. 1A is a perspective view of an example hinge assembly for an electronic device, depicting a hydraulic unit;

FIG. 1B is an exploded view of the example hinge assembly of FIG. 1A, depicting additional features;

FIG. 2 is a perspective view of an example hinge assembly, depicting a hydraulic unit to control movements of a first hinge member and a second hinge member;

FIG. 3A illustrates a schematic diagram of an example electronic device, depicting transmission of a force applied at a second hinge bracket to a first hinge bracket during opening of a display unit,

FIG. 3B illustrates a schematic diagram of the example electronic device of FIG. 3A, depicting transmission of a force applied at the second hinge bracket to the first hinge bracket during closing of the display unit;

FIG. 4A illustrates a perspective view of an example electronic device, depicting an example hinge assembly including a hydraulic unit; and

FIG. 4B illustrates an exploded view of the example electronic device of FIG. 4A depicting additional features.

### DETAILED DESCRIPTION

Hinged electronic devices such as laptop computers, tablet computers, personal digital assistants (PDAs), and flip mobile phones may include a base housing and a display housing connected by a pair of hinges. The display housing may include a display screen (e.g., a flexible display) and the base housing may include input devices, such as a keyboard, a pointing stick, mouse buttons, a touchpad, and/or a trackpad. The display housing may be attached to the base housing such that the display housing can be moved and/or rotated with respect to the base housing along an axis to hold the display at multiple positions. To achieve such rotation, the display housing can be attached to the base housing using a pair of hinges such that the display housing can be opened or closed using an external force.

For example, each hinge may include a hinge base and a hinge bracket pivotally connected to the hinge base. The hinge base may engage with the base housing and the hinge bracket may engage with the display housing to enable the display housing to rotate with respect to the base housing along an axis. However, such hinges may cause distortion (e.g., bending and twisting) of the display screen during swinging of one hinge while the other hinge is kept at the same position. For example, when the display housing is opened or closed by holding the display housing at one end (e.g., right-hand side), the force applied on the right-hand side hinge may not be transmitted to the left-hand side hinge and hence may cause the distortion of the display screen.

Examples described herein may provide a hinge assembly including a pair of hinges and a hydraulic unit to connect the pair of hinges. The hydraulic unit may provide synchronous movements between the pair of hinges and provide a frictional force (i.e., a torque force) to the pair of hinges using an incompressible fluid. In one example, the movement of hinge brackets associated with the pair of hinges may be connected using a hydraulic pipe filled with the incompressible fluid. Examples described herein may provide a flexible mechanical design as the hydraulic pipe can be routed like a cable to reduce the design limitations caused due to any structural interferences. Example described herein can be applicable to electronic devices with flexible displays.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described may be included in at least that one example, but not necessarily in other examples.

Examples described herein may provide a hinge assembly for an electronic device. The hinge assembly may include a pair of hinges to pivotally connect a display housing and a base housing, and a hydraulic unit connected between the pair of hinges to facilitate synchronous movements of the pair of hinges during rotation of the display housing relative to the base housing. In one example, the hydraulic unit may include two pistons disposed into two cylinders filled with incompressible fluid (e.g., oil) and connected to one another with a hydraulic pipe filled with the incompressible fluid. When a force is applied on one piston (e.g., during opening or closing of the display housing), the force can be transmitted to the second piston through the incompressible fluid.

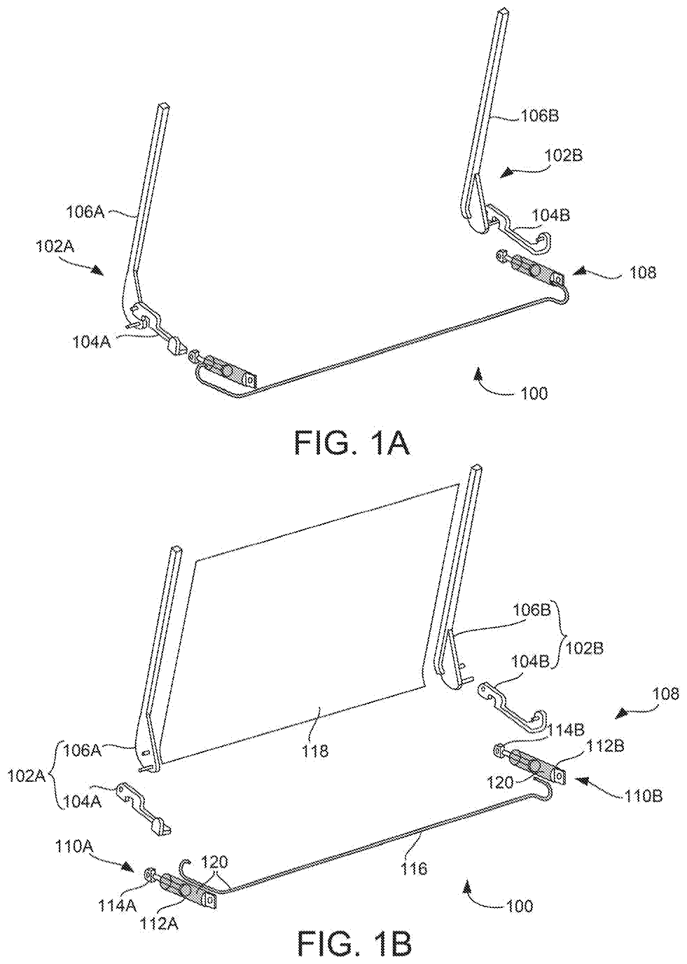

Referring to the figures, FIG. 1A is a perspective view of an example hinge assembly 100 for an electronic device, depicting a hydraulic unit 108. Example hinge assembly 100 may be a single-axis hinge assembly. Hinge assembly 100 may pivotally connect a first housing to a second housing along an axis, e.g., an axis of rotation. Example hinge assembly 100 may include a pair of hinges, i.e., a first hinge member 102A and a second hinge member 102B.

Further, first hinge member 102A may include a first hinge base 104A and a first hinge bracket 106A pivotally connected to first hinge base 104A. Second hinge member 102B may include a second hinge base 1048 and a second hinge bracket 1068 pivotally connected to second hinge base 104B. In some examples, first hinge bracket 106A and second hinge bracket 106B may engage with the first housing and first hinge base 104A and second hinge base 104B may engage with the second housing such that the first housing may be pivotally connected to the second housing.

Further, example hinge assembly 100 may include hydraulic unit 108 connected between first hinge member 102A and second hinge member 102B to provide synchronous movements between first hinge bracket 106A and second hinge bracket 106B. Example hydraulic unit 108 is explained in FIG. 1B.

FIG. 1B is an exploded view of example hinge assembly 100 of FIG. 1A, depicting additional features. As shown in FIG. 18, first hinge bracket 106A and second hinge bracket 106B may hold a display unit 118. Example display unit 118 may be a flexible display.

Further, hydraulic unit 108 may include a first piston-cylinder unit 110A having a first piston 114A disposed in a first cylinder 112A. In one example, first piston-cylinder unit 110A may be connected to first hinge member 102A. Furthermore, hydraulic unit 108 may include a second piston-cylinder unit 110B having a second piston 114B disposed in a second cylinder 112B. In one example, second piston-cylinder unit 110B may be connected to second hinge member 102B. In some examples, dimensions (e.g., sizes and shapes) of first piston-cylinder unit 110A and second piston-cylinder unit 1108 may be equal. Also, hydraulic unit 108 may include a hydraulic pipe 116 connected between first piston-cylinder unit 110A and second piston-cylinder unit 110B.

In one example, first piston 114A and second piston 114B may be connected to first hinge bracket 106A and second hinge bracket 106B, respectively. First piston 114A and second piston 114B can be extractable and retractable in first cylinder 112A and second cylinder 112B, respectively. For example, retracting first piston 114A and second piston 114B may rotate first hinge bracket 106A and second hinge bracket 106B to open the display unit and extracting first piston 114A and second piston 114B may rotate first hinge bracket 106A and second hinge bracket 106B to close the display unit.

Further, one end of first cylinder 112A and second cylinder 112B may be fixedly secured to first hinge base 104A and second hinge base 104B, respectively. Further, other end of first cylinder 112A and second cylinder 112B can be flexible to reduce any structural interferences caused during rotation of the first housing relative to the second housing (i.e,. during rotation of first hinge bracket 106A and second hinge bracket 106B).

Furthermore, hydraulic unit 108 may include hydraulic fluid 120 filled in first cylinder 112A, second cylinder 112B, and hydraulic pipe 116. First piston-cylinder unit 110A and second piston-cylinder unit 110B may push or pull hydraulic fluid 120 between first cylinder 112A and second cylinder 112B through hydraulic pipe 116 to provide synchronous movements between first hinge bracket 106A and second hinge bracket 106B. In some examples, hydraulic fluid 120 may be pulled or pushed between first cylinder 112A and second cylinder 112B based on a direction of rotation of first hinge bracket 106A and second hinge bracket 106B relative to first hinge base 104A and second hinge base 104B.

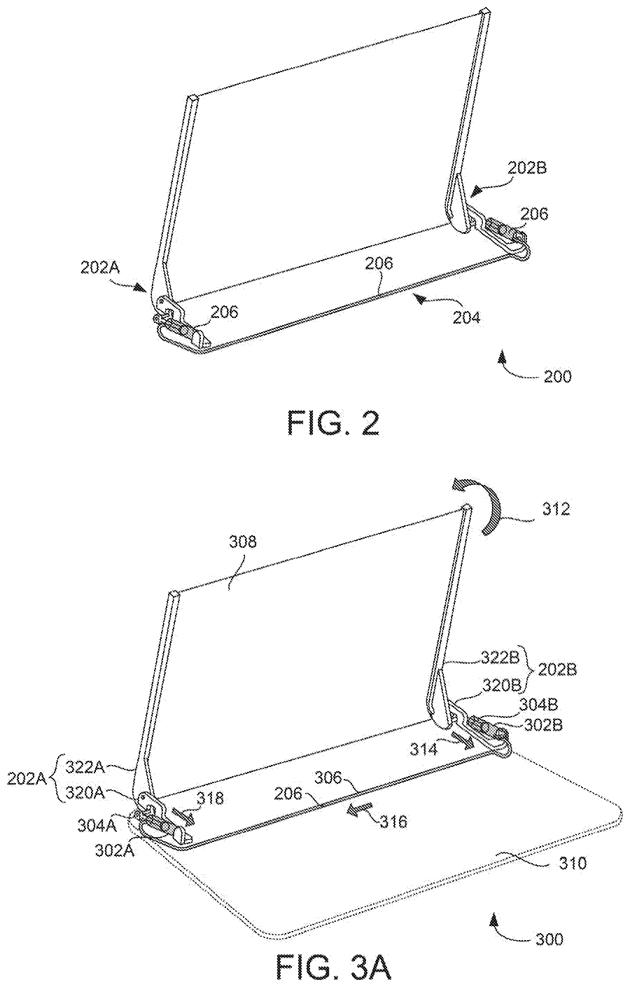

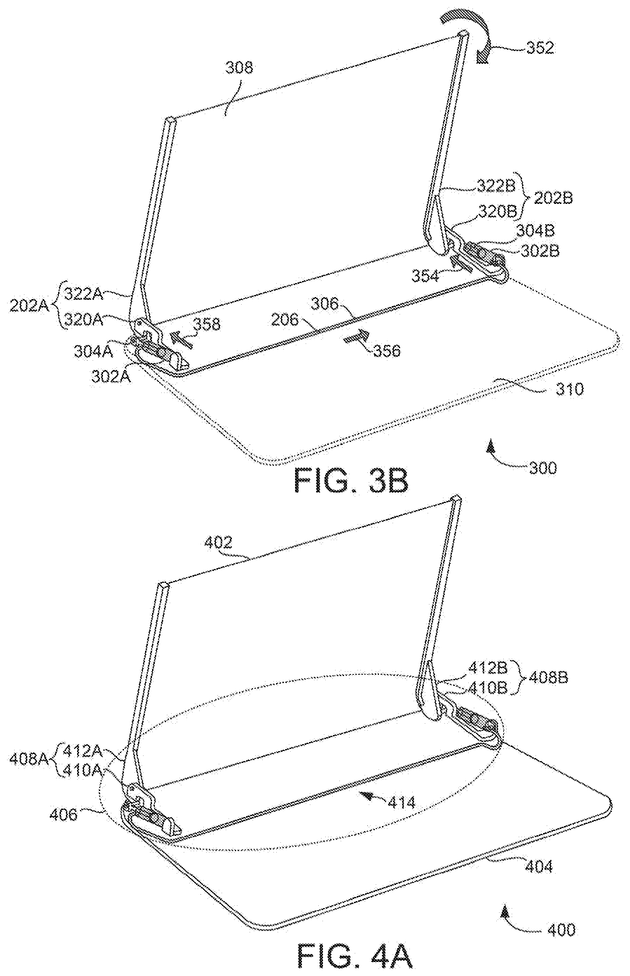

FIG. 2 is a perspective view of an example hinge assembly 200, depicting a hydraulic unit 204 to control movements of a first hinge member 202A and a second hinge member 202B. Example hinge assembly 200 may include first hinge member 202A, second hinge member 202B, and hydraulic unit 204 connected between first hinge member 202A and second hinge member 2028. In one example, hydraulic unit 204 may control movements of first hinge member 202A and second hinge member 202B via an incompressible fluid 206. An example mechanism to control movements of first hinge member 202A and second hinge member 2028 is explained in FIGS. 3A and 3B.

FIG. 3A illustrates a schematic diagram of an example electronic device 300, depicting transmission of a force applied at a second hinge bracket 3226 to a first hinge bracket 322A during opening of a display unit 308. For example, similarly named elements of FIG. 3A may be similar in structure and/or function to elements described with respect to FIG. 2. First hinge member 202A may include a first hinge base 320A and first hinge bracket 322A pivotally connected to first hinge base 320A.

Further, second hinge member 202B may include a second hinge base 320B and second hinge bracket 322B pivotally connected to second hinge base 320B. In one example, hydraulic unit (e.g., hydraulic unit 204 of FIG. 2) may control movements of first hinge member 202A and second hinge member 202B by transmitting a force applied at first hinge bracket 322A to second hinge bracket 322B or vice versa via incompressible fluid 206.

As shown in FIG. 3A, first and second hinge brackets 322A and 322B can be connected to display unit 308 and first and second hinge bases 320A and 320B can be connected to a base housing 310 (e.g., a keyboard unit) such that display unit 308 can be pivotably coupled to base housing 310.

Hydraulic unit (e.g., hydraulic unit 204 of FIG. 2) may include a first cylinder 302A filled with incompressible fluid 206 and connected to first hinge base 320A (e.g., at one end of first cylinder 302A). Further, hydraulic unit 204 may include a first piston 304A disposed in first cylinder 302A (e.g., at another end of first cylinder 302A) and connected to first hinge bracket 322A such that first hinge bracket 322A and first piston 304A can be moved with each other.

Furthermore, hydraulic unit 204 may include a second cylinder 302B filled with incompressible fluid 206 and connected to second hinge base 320B (e.g., at one end of second cylinder 302B). Also, hydraulic unit 204 may include a second piston 30413 disposed in second cylinder 3026 (e.g., at another end of second cylinder 302B) and connected to second hinge bracket 322B such that second hinge bracket 322B and second piston 304B can be moved with each other. In some examples, first and second pistons 304A and 304B and first and second cylinders 302A and 302B may be identical in shape and size.

Further, hydraulic unit 204 may include a hydraulic pipe 306 filled with incompressible fluid 208 and connected between first cylinder 302A and second cylinder 302B to transfer the force between first hinge bracket 322A and second hinge bracket 322B via first piston 304A and second piston 304B. In one example, one end of hydraulic pipe 306 may be connected to a front portion of second cylinder 302B and another end of hydraulic pipe 306 may be connected to a rear portion of first cylinder 302A. In alternate examples, one end of hydraulic pipe 306 can also be connected to a front portion of first cylinder 302A and another end of hydraulic pipe 306 may be connected to a rear portion of second cylinder 302B such that first piston 304A and second piston 304B are to move in the same direction during rotations of first hinge bracket 322A and second hinge bracket 322B.

Consider an example where display unit 308 can be opened by swinging second hinge bracket 322B at right-hand right-hand side of display unit 308 (e.g., by holding display unit 308 at the right-hand side as shown by arrow 312). In this example, second hinge bracket 322B can drive second piston 304B to move forward (e.g,, as shown by arrow 314). Further, second piston 304B may push incompressible fluid 206 (i.e., hydraulic fluid) from second cylinder 302B to first cylinder 302A through hydraulic pipe 306 (e.g. as shown by arrow 318).

Furthermore, incompressible fluid 206 may push first piston 304A to move forward (e..g as shown by arrow 318). In addition, first piston 304A may drive first hinge bracket 322A to swing in the direction of rotation of second hinge bracket 322B. Since the dimensions are same for first and second pistons 304A and 304B and first and second cylinders 302A and 302B, and due to the properties of incompressible fluid 206, the movements of first hinge bracket 322A and second hinge bracket 322B can be synchronized.

In the example shown in FIG, 3A, rotational motion of second hinge bracket 322B may be converted into linear motion of second piston 304B and the linear motion of first piston 304A may be converted into rotational motion of first hinge bracket 322A to provide the synchronous movements of first hinge bracket 322A and second hinge bracket 322B.

Similarly, when display unit 308 is opened by swinging first hinge bracket 322A at a left-hand side of display unit 308 (e.g., by holding display unit 308 at the left-hand side), first hinge bracket 322A can drive first piston 304A to move forward (e.g., as shown by arrow 318), which in turn can pull incompressible fluid 206 to first cylinder 302A. In this example, incompressible fluid 206 can be pulled from second cylinder 302B to first cylinder 302A through hydraulic pipe 306 (e.g., as shown by arrow 316). Furthermore, incompressible fluid 206 may pull second piston 304B to move forward (e.g., as shown by arrow 314). In addition, second piston 304B may drive second hinge bracket 322B to swing to provide synchronous movements between first hinge bracket 322A and second hinge bracket 322B.

FIG. 38 illustrates a schematic diagram of example electronic device 300, depicting transmission of a force applied at a second hinge bracket 322B to a first hinge bracket 322A during closing of a display unit 308. For example, similarly named elements of FIG. 38 may be similar in structure and/or function to elements described with respect to FIGS. 2 and 3A.

Consider an example where display unit 308 can be closed by swinging second hinge bracket 322B at the right-hand side (e.g., by holding display unit 308 at the right-hand side as shown by arrow 352). In this example, second hinge bracket 322B may drive second piston 304B to move backward (e,g., as shown by arrow 354), Further, second piston 304B may pull incompressible fluid 206 from first cylinder 302A to second cylinder 302B through hydraulic pipe 306 (e.g.. as shown by arrow 356).

Furthermore, incompressible fluid 206 may pull first piston 304A to move backward (e.g, as shown by arrow 358). In addition, first piston 304A may drive first hinge bracket 322A to swing (i.e., in the direction of rotation of second hinge bracket 322B). Since the dimensions are same for first and second pistons 304A and 304B and first and second cylinders 302A and 302B, and due to the properties of incompressible fluid 206, the movements of first hinge bracket 322A and second hinge bracket 322B can be synchronized.

Similarly, when display unit 308 is closed by swinging first hinge bracket 322A at, the left-hand side (e.g., by holding display unit 308 at the left-hand side), first hinge bracket 322A can drive first piston 304A to move backward (e.g., as shown by arrow 358), which in turn can push incompressible fluid 206 to second cylinder 3028. In this example, incompressible fluid 208 can be pushed from first cylinder 302A to second, cylinder 302B through hydraulic pipe 306 (e.g., as shown by arrow 356). Furthermore, incompressible fluid 206 may push second piston 304B to move backward (e.g., as shown by arrow 354). In addition, second piston 304B may drive second hinge bracket 322B to swing to provide synchronous movements between first hinge bracket 322A and second hinge bracket 322B.

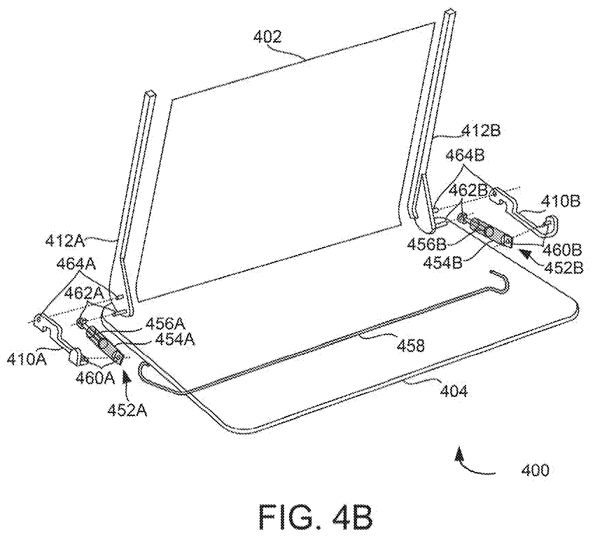

FIG. 4A illustrates a perspective view of an example electronic device 400, depicting an example hinge assembly 406 including a hydraulic unit 414. As shown in FIG. 4A, example electronic device 400 may include a display housing 402, a base housing 404, and hinge assembly 406 to pivotally connect display housing 402 and base housing 404. Example electronic device 400 may be a computing system, for example, a laptop, a convertible device, a PDA, a notebook, a sub-notebook, a personal gaming device, or other computing device with display housing 402 closeable onto base housing 404, Electronic device 400 may include a pair of hinges 408A and 408B to pivotally connect display housing 402 and base housing 404. Display housing 402 can be rotated between a closed position and an open position.

For example, base housing 404 may house a keyboard, a battery,, a touchpad, and so on, Display housing 402 may house a display (e.g., a touchscreen display). Example display may be a flexible display. In other examples, display may also include liquid crystal display (LCD), light emitting diode (LED), electro-luminescent (EL) display, micro LED display, or the like, Electronic, device 400 may be equipped with other components such as a camera, audio/video devices, and the like, depending on the functions of electronic device 400. Hinge assembly 406 may be pivotally connected to display housing 402 and base housing 404 along a pivot axis. Hinge assembly 406 may allow display housing 402 to rotate in directions about the pivot axis relative to base housing 404.

Further, hinge assembly 406 may include first hinge 408A, second hinge 408B, and hydraulic unit 414 connected between first hinge 408A and second hinge 408B. First hinge 408A may include a first hinge base 410A connected to base housing 404. Further, first hinge 408A may include a first hinge bracket 412A pivotally connected to first hinge base 410A and fixedly connected to display housing 402.

Second hinge 408B may include a second hinge base 410B connected to base housing 404. Further, second hinge 408Bmay include a second hinge bracket 412B pivotally connected to second hinge base 410B and fixedly connected to display housing 402. In some examples, first hinge bracket 412A and second hinge bracket 412B may hold the flexible display.

Furthermore, hydraulic unit 414 may be connected between first hinge 408A and second hinge 408B to provide synchronous movements between first hinge bracket 412A and second hinge bracket 412B during rotations of display housing 402 relative to base housing 404. Example hydraulic unit 414 may be described in FIG. 4B.

FIG. 4B illustrates a perspective view ;of example electronic device 400 of FIG. 4A, depicting additional features. For example, similarly named elements of FIG. 4B may be similar in structure and/or function to elements described with respect to FIG. 4A. As shown in FIG. 4B, first hinge bracket 412A may be pivotally connected to first hinge base 410A via a coupling structure 464A, and second hinge bracket 412B may be pivotally connected to second hinge base 410B via a coupling structure 464B. For example, coupling structures 464A and 464B may include protrusions defined in first and second hinge brackets 412A and 412B, and recesses/openings defined in, first and second hinge bases 410A and 410B to rotatably receive a respective one of the protrusions.

Hydraulic unit 414 may include a first piston-cylinder unit 452A, a second piston-cylinder unit 452B, and a hydraulic pipe 458 connected between first piston-cylinder unit 452A and second piston-cylinder unit 4528. First piston-cylinder unit 452A may include a first cylinder 454A mounted on first hinge base 410A Further, first piston-cylinder unit 452A may include a first piston 456A disposed in first cylinder 454A and connected to first hinge bracket 412A.

Second piston-cylinder unit 452B may include a second cylinder 454B mounted on second hinge base 410B. Further, second piston-cylinder unit 452B may include a second piston 456B disposed in second cylinder 454B and connected to second hinge bracket 412B. Hydraulic unit 414 may include hydraulic fluid filled in first piston-cylinder unit 452A second piston-cylinder unit 452B, and hydraulic pipe 458.

As shown in FIG. 4B, one end of first cylinder 454A may be connected to first hinge base 410A via a coupling structure 460A, and one end of second cylinder 4548 may be connected to second hinge base 410B via a coupling structure 460B, For example, coupling structures 460A and 460B may include protrusions defined in first and second hinge bases 410A and 410B, and recesses/openings defined in first and second cylinders 454A and 454B to rotatably receive a respective one of the protrusions.

Further, first piston 456A may be connected to first hinge bracket 412A via a coupling structure 462A, and second piston 456B may be connected to second hinge bracket 412B via a coupling structure 462B. For example, coupling structures 462A and 462B may include protrusions defined in first and second hinge brackets 412A and 412B, and recesses/openings defined in first and second pistons 456A and 456B to rotatably receive a respective one of the protrusions.

In one example, first piston-cylinder unit 452A and second piston-cylinder unit 452B may push or pull the hydraulic fluid between first cylinder 454A and second cylinder 454B via hydraulic pipe 458 based on a direction of rotation of display housing 402 relative to base housing 404. In some examples, hydraulic pipe 458 may be connected between first piston-cylinder unit 452A and second piston-cylinder unit 452B such that first piston 458A and second piston 456B are to synchronously move forward during opening of display housing 402 relative to base housing 404, and to synchronously move backward during closing of display housing 402 relative to base housing 404.

Even though FIGS. 1-4 illustrate an example hinge assembly, examples described herein can also be used in other hinge structures, provided that a first bracket rotates in directions about a pivot axis relative to a second bracket. Further, FIGS. 1-4 illustrate an example hydraulic mechanism connected between a pair of hinges of an electronic device, however, any other hydraulic mechanism can also be used to connect the pair of hinges such that the hydraulic mechanism can provide synchronous movements between the pair of hinges to reduce the distortion of the display screen during opening or closing the display screen. Furthermore, the hydraulic mechanism can also provide frictional resistance to hold the display screen at multiple positions relative to the base housing.

It may be noted that the above-described examples of the present solution are for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A hinge assembly comprising:
a first hinge member comprising:
a first hinge base; and
a first hinge bracket pivotally connected to the first hinge base;
a second hinge member comprising:
a second hinge base; and,
a second hinge bracket pivotally connected to the second hinge base; and
a hydraulic unit connected between the first hinge member and the second hinge member to provide synchronous movements between the first hinge bracket and the second hinge bracket.

2. The hinge assembly of claim 1, wherein the hydraulic unit comprises:
a first piston-cylinder unit having a first piston disposed in a first cylinder, wherein the first piston-cylinder unit is to connect to the first hinge member;
a second piston-cylinder unit having a second piston disposed in a second cylinder, wherein the second piston-cylinder unit is to connect to the second hinge member; and
a hydraulic pipe connected between the first p ton-cylinder unit and the second piston-cylinder unit.

3. The hinge assembly of claim 2, wherein one end of the first cylinder and the second cylinder are fixedly secured to the first hinge base and the second hinge base, respectively, and wherein the first piston and the second piston are connected to the first hinge bracket and the second hinge bracket, respectively.

4. The hinge assembly of claim 2, wherein the hydraulic unit further comprises:
hydraulic fluid, wherein the first piston-cylinder unit and the second piston-cylinder unit are to push or pull the hydraulic fluid between the first cylinder and the second cylinder through the hydraulic pipe based on a direction of rotation of the first hinge bracket and the second hinge bracket relative to the first hinge base and the second hinge base,

5. The hinge assembly of claim 1, wherein the first hinge bracket and the second hinge bracket are to hold a display unit, wherein the display unit comprises a flexible display.

6. A hinge assembly comprising;
a first hinge member;
a second hinge member; and
a hydraulic unit connected between the first hinge member and the second hinge member to control movements of the first hinge member and the second hinge member via an incompressible fluid.

7. The hinge assembly of claim 6, wherein the first hinge member comprises a first hinge base and a first hinge bracket pivotally connected to the first hinge base, and wherein the second hinge member comprises a second hinge base and a second hinge bracket pivotally connected to the second hinge base.

8. The hinge assembly of claim 7, wherein the hydraulic unit comprises:
a first cylinder filled with the incompressible fluid and connected to the first hinge base;
a first piston disposed in the first cylinder and connected to the first hinge bracket;
a second cylinder filled with the incompressible fluid and connected to the second hinge base;
a second piston disposed in the second cylinder and connected to the second hinge bracket; and
a hydraulic pipe filled with the incompressible fluid and connected between the first cylinder and the second cylinder to transfer a force between the first hinge bracket and the second hinge bracket via the first piston and the second piston.

9. The hinge assembly of claim 8, wherein one end of the hydraulic pipe is connected to a front portion of the first cylinder and another end of the hydraulic pipe is connected to a rear portion of the second cylinder such that the first piston and the second piston are to move in a same direction during rotations of the first hinge bracket and the second hinge bracket.

10. An electronic device comprising:
a display housing;
a base housing;
a hinge assembly to pivotally connect the display housing and the base housing, wherein the hinge assembly comprises:
a first hinge comprising:
a first hinge base connected to the base housing; and
a first hinge bracket pivotally connected to the first hinge base and fixedly connected to the display housing;
a second hinge comprising:
a second hinge base connected to the base housing; and
a second hinge bracket pivotally connected to the second hinge base and fixedly connected to the display housing; and
a hydraulic unit connected between the first hinge and the second hinge to provide synchronous movements between the first hinge bracket and the second hinge bracket during rotations of the display housing relative to, the base housing.

11. The electronic device of claim 10, wherein the hydra unit comprises:
a first piston-cylinder unit comprising:
a first cylinder mounted on the first hinge base; and
a first piston disposed in the first cylinder and connected to the first hinge bracket;
a second piston-cylinder unit comprising:
a second cylinder mounted on the second hinge base; and
a second piston disposed in the second cylinder and connected to the second hinge bracket; and
a hydraulic pipe connected between the first piston-cylinder unit and the second piston-cylinder unit.

12. The electronic device of claim 11, wherein the hydraulic pipe is connected between the first piston-cylinder unit and the second piston-cylinder unit such that the first piston and the second piston are to synchronously move forward during opening of the display housing relative to the base housing, and the first piston and the second piston are to synchronously move backward during closing of the display housing relative to the base housing.

13. The electronic device of claim 11, wherein the hydraulic unit further comprises:
hydraulic fluid, wherein the first piston-cylinder unit and the second piston-cylinder unit are to push or pull the hydraulic fluid between the first cylinder and the second cylinder via the hydraulic pipe based on a direction of rotation of the display housing relative to the base housing,

14. The electronic device of claim 11, wherein one end of the first cylinder is connected to the first hinge base via a first coupling structure, wherein one end of the second cylinder is connected to the second hinge base via a second coupling structure, wherein the first piston is connected to the first hinge bracket via a third coupling structure, and wherein the second piston is connected to the second hinge bracket via a fourth coupling structure.

15. The electronic device of claim 10, wherein the first hinge bracket is pivotally connected to the first hinge base via a fifth coupling structure, and wherein the second hinge bracket is pivotally connected to the second hinge base via a sixth coupling structure.
